(19) United States
(12) Patent Application Publication
(10) Pub. No.: US 2022/0036111 A1
(43) Pub. Date: Feb. 3, 2022

(54) METHOD AND DEVICE FOR ASSOCIATING PANORAMIC IMAGE WITH POINT OF INTEREST, ELECTRONIC DEVICE AND STORAGE MEDIUM

(71) Applicant: Beijing Baidu Netcom Science Technology Co., Ltd, Beijing (CN)

(72) Inventors: Guocai Bai, Beijing (CN); Jiankang Xin, Beijing (CN)

(73) Assignee: Beijing Baidu Netcom Science Technology Co., Ltd, Beijing (CN)

(21) Appl. No.: 17/451,304

(22) Filed: Oct. 18, 2021

(30) Foreign Application Priority Data
Dec. 25, 2020 (CN) 202011561039.2

(51) Int. Cl. G06K 9/32; G06T 3/40; G06T 7/00; G06T 7/70

(52) U.S. Cl. CPC G06K 9/3258; G06T 3/4038; G06T 7/0002; G06T 2207/20084; G06K 2209/01; G06K 2209/21; G06T 2207/30168; G06T 7/70

(57) ABSTRACT

This application provides a method and a device for associating a panoramic image with a point of interest, an electronic device and a storage medium. A specific implementation solution is as follows: performing text recognition on a panoramic image associated with a target point of interest, and determining target text information; acquiring a set of panoramic images including the target text information among a plurality of panoramic images associated with the target point of interest; acquiring a panoramic screenshot corresponding to each panoramic image in the set of panoramic images to acquire a set of panoramic screenshots, where one panoramic image is formed by splicing a plurality of panoramic screenshots; and determining a target panoramic screenshot in the set of panoramic screenshots, and associating the target panoramic screenshot with the target point of interest, where the target panoramic screenshot includes the target text information.

### CROSS-REFERENCE TO RELATED APPLICATION

This application claims a priority to Chinese Patent Application No. 202011561039.2 filed on Dec. 25, 2020, the disclosure of which is incorporated in its entirety by reference herein.

### TECHNICAL FIELD

The present disclosure relates to the technical field of image recognition of image processing technologies, in particular to a method and a device for associating a panoramic image with a point of interest, an electronic device and a storage medium.

### BACKGROUND

A panoramic image is an image stitched with one or more sets of photos taken by a camera from multiple angles. Because it may provide a 360-degree viewing angle of a display space, the panoramic image has been widely used in an electronic map. In the electronic map, a point of interest (POI) plays an important role in user retrieval and navigation planning.

### SUMMARY

A method and a device for associating a panoramic image with a point of interest, an electronic device and a storage medium are provided in the present disclosure.

In one aspect, a method for associating a panoramic image with a point of interest is provided. The method includes: performing text recognition on a panoramic image associated with a target point of interest, and determining target text information; acquiring a set of panoramic images including the target text information among a plurality of panoramic images associated with the target point of interest; acquiring a panoramic screenshot corresponding to each panoramic image in the set of panoramic images to acquire a set of panoramic screenshots, where one panoramic image is formed by splicing a plurality of panoramic screenshots; and determining a target panoramic screenshot in the set of panoramic screenshots, and associating the target panoramic screenshot with the target point of interest, where the target panoramic screenshot includes the target text information.

In another aspect, a device for associating a panoramic image with a point of interest is provided. The device includes: a determination module, configured to perform text recognition on a panoramic image associated with a target point of interest, and determine target text information; a first acquisition module, configured to acquire a set of panoramic images including the target text information among a plurality of panoramic images associated with the target point of interest; a second acquisition module, configured to acquire a panoramic screenshot corresponding to each panoramic image in the set of panoramic images to acquire a set of panoramic screenshots, where one panoramic image is formed by splicing a plurality of panoramic screenshots; and an association module, configured to determine a target panoramic screenshot in the set of panoramic screenshots, and associate the target panoramic screenshot with the target point of interest, where the target panoramic screenshot includes the target text information.

In another aspect, an electronic device is provided, including: at least one processor; and a memory communicatively coupled to the at least one processor. The memory stores thereon an instruction that is executable by the at least one processor, and the instruction, when executed by the at least one processor, causes the at least one processor to perform the method in the above aspect.

In another aspect, a non-transitory computer-readable storage medium is provided, which stores a computer instruction thereon. The computer instruction is configured to cause a computer to perform the method in the above aspect.

In another aspect, a computer program product is provided, which includes a computer program. The computer program is executed by a processor to implement the method in the above aspect.

In the present disclosure, the panoramic image is associated with the point of interest automatically, as compared with a manual operation in the prior art of associating a panoramic image with a point of interest, subjective factors caused by the manual operation can be avoided, thereby improving the association efficiency.

It should be appreciated that the content described in this section is not intended to identify key or important features of the embodiments of the present disclosure, nor is it intended to limit the scope of the present disclosure. Other features of the present disclosure are easily understood based on the following description.

### BRIEF DESCRIPTION OF THE DRAWINGS

The accompanying drawings are used for better understanding of solutions, but shall not be construed as limiting the present disclosure. In these drawings,

FIG. 1 is a flowchart of a method for associating a panoramic image with a point of interest according to an embodiment of the present disclosure;

FIG. 2 is a schematic diagram of a scenario of a panoramic image corresponding to a panoramic screenshot in the method of FIG. 1;

FIG. 3 is a structural diagram of a device for associating a panoramic image with a point of interest according to an embodiment of the present disclosure; and

FIG. 4 is a block diagram of an electronic device used to implement the method for associating the panoramic image with the point of interest in the embodiment of the present disclosure.

### DETAILED DESCRIPTION

The following describes exemplary embodiments of the present disclosure with reference to accompanying drawings. Various details of the embodiments of the present disclosure are included to facilitate understanding, and should be considered as being merely exemplary. Therefore, those of ordinary skill in the art should be aware that various changes and modifications can be made to the embodiments described herein without departing from the scope and spirit of the present disclosure. Likewise, for clarity and conciseness, descriptions of well-known functions and structures are omitted below.

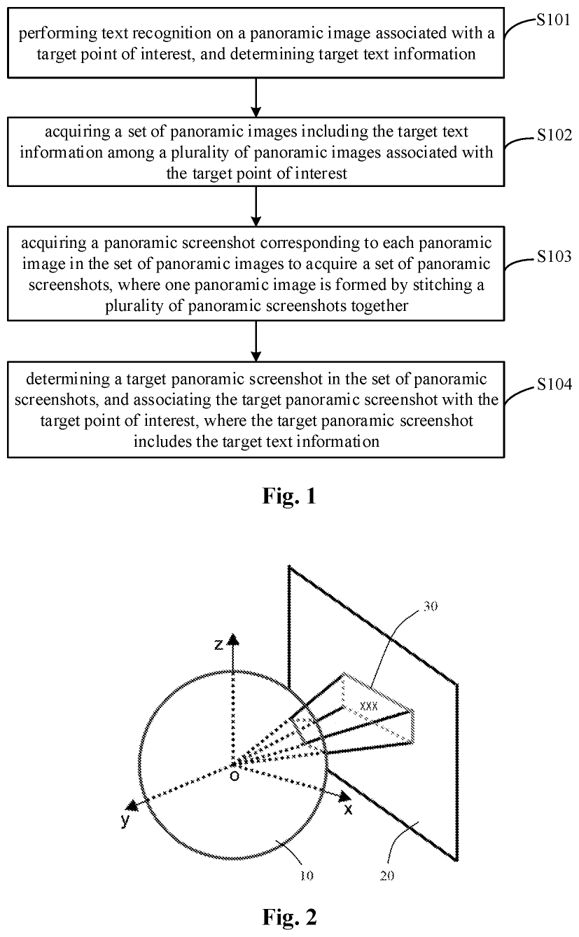

Referring to FIG. 1, FIG. 1 is a flowchart of a method for associating a panoramic image with a point of interest according to an embodiment of the present disclosure. As shown in FIG. 1, the method includes the following steps.

Step S101, performing text recognition on a panoramic image associated with a target point of interest, and determining target text information.

It should be appreciated that, the method provided in the embodiments of the present disclosure may be applied to a device for associating the panoramic image with the point of interest, such as a mobile phone, a tablet computer, a notebook computer, a desktop computer, and another electronic device. For the convenience of description, a specific description will be given hereinafter in such a manner that the method is performed by the device.

In an embodiment of the present disclosure, the device may first acquire a target point of interest before performing text recognition on the panoramic image associated with the target point of interest. For example, the device is a mobile phone, in the case that an electronic map application interface is displayed on the mobile phone, the device may acquire a target point of interest by receiving an input operation of a user on the mobile phone. For example, the device may acquire a name of the target point of interest inputted by the user, or the device may acquire the target point of interest specified by the user in the electronic map application.

Further, in the case that the target point of interest has been acquired, text recognition is performed on the panoramic image associated with the target point of interest, so as to acquire the text information in the panoramic image, and determine the target text information from the acquired text information. It should be noted that, there may be multiple panoramic images associated with the target point of interest, and the panoramic image associated with the target interest point in this step may be any one of the panoramic images associated with the target point of interest. It should be appreciated that, one panoramic image may include multiple pieces of text information, and the target text information may be one of the multiple pieces of text information. For example, the target point of interest is a cultural park in city A, and the target text information may be “cultural park”.

Optionally, the panoramic image associated with the target point of interest may be identified based on an optical character recognition (OCR) technology in an embodiment of the present disclosure, so as to acquire the text information in the panoramic image. Of course, the text recognition may also be implemented in other manners, which is not defined specifically in the embodiments of the present disclosure.

Step S102, acquiring a set of panoramic images including the target text information among a plurality of panoramic images associated with the target point of interest.

It should be appreciated that, the point of interest is usually associated with a plurality of panoramic images. For example, panoramic images associated with the cultural park in city A may include a panoramic image acquired based on a viewing angle of an entrance of the cultural park, a panoramic image acquired based on a viewing angle of an exit of the cultural park, a panoramic image acquired based on a viewing angle of a lake of the cultural park and a panoramic image acquired based on a viewing angle of a rest pavilion of the cultural park, etc.

In an embodiment of the present disclosure, after the target point of interest has been acquired, all the panoramic images associated with the target point of interest may be acquired. After the target text information has been determined, a panoramic image including the target text information may be acquired from all the panoramic images associated with the target point of interest, so as to acquire a set of panoramic images. The set of panoramic images includes at least one panoramic image.

For example, the target point of interest is the cultural park in city A, and the target text information is “cultural park”, it should be appreciated that only a part of the panoramic images associated with the target point of interest includes the target text information of “cultural park”, such as a panoramic image based on a front viewing angle of a main entrance of the cultural park, a panoramic image based on a left front viewing angle of the main entrance of the cultural park, etc. The set of panoramic images may be acquired based on these panoramic images including the target text information.

Step S103, acquiring a panoramic screenshot corresponding to each panoramic image in the set of panoramic images to acquire a set of panoramic screenshots, where one panoramic image is formed by stitching a plurality of panoramic screenshots together.

It should be appreciated that, each panoramic image is formed by stitching panoramic screenshots having different angle information together, so as to acquire a panoramic image having a 360-degree viewing angle. In the embodiment of the present disclosure, after the set of panoramic images including the target text information has been acquired, respective panoramic screenshots corresponding to panoramic images in the set of panoramic images are acquired, and the set of panoramic screenshots is acquired.

It should be appreciated that, each panoramic image includes a plurality of panoramic screenshots, a part of the panoramic screenshots corresponding to each panoramic image may be acquired, so as to acquire the set of panoramic screenshots. For example, a first panoramic screenshot that includes the target text information among the panoramic screenshots corresponding to each panoramic image may be acquired, and the set of panoramic screenshots may be acquired based on the first panoramic screenshot corresponding to each panoramic image. In this way, each panoramic screenshot in the set of panoramic screenshots includes the target text information.

For example, the target text information is “cultural park”. For the panoramic image that includes the target text information, such as the panoramic image based on the front viewing angle of the main entrance of the cultural park, not every panoramic screenshot of panoramic screenshots which are stitched together to form the panoramic image includes the target text information, because the panoramic image has a 360-degree viewing angle. Only a panoramic screenshot acquired based on a viewing angle of facing the main entrance of the cultural park includes “cultural park”, while a panoramic screenshot acquired based on a viewing angle of backing to the main entrance of the cultural park does not include the target text information. In the embodiment of the present disclosure, a first panoramic screenshot including the target text information in each panoramic image may be acquired, and the set of panoramic screenshots is acquired based on the first panoramic screenshot.

Step S104, determining a target panoramic screenshot in the set of panoramic screenshots, and associating the target panoramic screenshot with the target point of interest, where the target panoramic screenshot includes the target text information.

In an embodiment of the present disclosure, after the set of panoramic screenshots has been acquired, the target panoramic screenshot is determined from the set of panoramic screenshots, and the target panoramic screenshot includes the target text information. That is, one panoramic screenshot is determined as the target panoramic screenshot from all panoramic screenshots including the target text information. For example, the target panoramic screenshot may be a panoramic screenshot having a widest viewing angle, or a panoramic screenshot having a best image quality, etc.

Optionally, the determining the target panoramic screenshot in the set of panoramic screenshots includes: acquiring a score value of each panoramic screenshot in the set of panoramic screenshots based on a preset scoring rule, and determining the target panoramic screenshot in the set of panoramic screenshots based on the score value.

In an embodiment of the present disclosure, the preset scoring rule may be preset by the user. For example, the preset scoring rule may be as follows. The higher the image brightness of the panoramic screenshot, the larger the corresponding score value, or the larger the viewing angle of the panoramic screenshot, the higher the corresponding score value, or the more image colors corresponding to the panoramic screenshot, the higher the corresponding score value, etc. Further, after the score value of each panoramic screenshot in the set of panoramic screenshots has been acquired based on the preset scoring rule, and the panoramic screenshot having a higher score value may be determined as the target panoramic screenshot. In this way, the target panoramic screenshot may be determined based on the preset scoring rule, instead of manual operation, so that subjective factors caused by the manual operation can be avoided, and the target panoramic screenshot may be selected in a more objective and smarter manner.

In an optional embodiment, the determining the target panoramic screenshot in the set of panoramic screenshots may include:

acquiring an image parameter of each panoramic screenshot in the set of panoramic screenshots, where the image parameter includes at least one of following items: image brightness, image contrast, a display position of the target text information in the panoramic screenshot, a display size of the target text information in the panoramic screenshot, and angle information corresponding to the panoramic screenshot;

acquiring a score value of each panoramic screenshot based on a preset scoring model, where the preset scoring model is a network model of which an input is the image parameters and an output is the score value; and

determining the panoramic screenshot having a highest score value as the target panoramic screenshot.

In this embodiment, the target panoramic screenshot may also be determined based on the score value outputted by the preset scoring model. It should be appreciated that the preset scoring model is a neural network model, and is self-learned and trained by using sample image parameters of the panoramic screenshots and respective corresponding target score values inputted by the user, so as to acquire a correlation between the image parameters of the panoramic screenshots and the score values. For example, the sample image parameters of the panoramic screenshot and a target score value corresponding to the panoramic screenshot are acquired, the sample image parameters of the panoramic screenshot are inputted into the preset scoring model, and a test score value is outputted by the preset scoring model. A loss value between the test score value and the target score value is calculated, backpropagation is performed to optimize the preset scoring model, and iterative processing is performed to train the preset scoring model.

The influence of each image parameter on the score value may be as follows. The image brightness is directly proportional to the score value. The image contrast is directly proportional to the score value. The closer the position of the target text information in the panoramic screenshot is to the middle of the panoramic screenshot, the higher the score value. The closer the display size of the target text information in the panoramic screenshot is to a preset display size, the higher the score value. The more detailed the angle information corresponding to the panoramic screenshot, the higher the score value. Of course, there may be other relationships between each image parameter and the score value, which are not specifically defined in the embodiments. In addition, the score value corresponding to the image parameter may be an average value of respective score values of all the image parameters, or a weighted average value of respective score values of all the image parameters, where each image parameter may have a corresponding weight value.

In this embodiment, after the set of panoramic screenshots has been acquired, the image parameters of each panoramic screenshot in the set of panoramic screenshots are acquired, and used as an input of the preset scoring model, the score value corresponding to each panoramic screenshot outputted by the preset scoring model is acquired and compared with each other, and the panoramic screenshot having the highest score is determined as the target panoramic screenshot. In this way, the panoramic screenshot may be scored automatically based on the preset scoring model, so that the panoramic screenshot may be scored in a more objective manner, thereby avoiding the influence of subjective factors on determining the target panoramic screenshot. In addition, a scoring basis of the preset scoring model may be acquired based on a plurality of image parameters corresponding to the panoramic screenshot, so that the panoramic screenshot may be scored in a more comprehensive manner, thereby acquiring the target panoramic screenshot having a better image quality.

Further, after the target panoramic screenshot has been determined, the target panoramic screenshot is associated with the target point of interest.

Optionally, the associating the target panoramic screenshot with the target point of interest includes: acquiring a target panoramic image corresponding to the target panoramic screenshot; acquiring angle information of the target panoramic screenshot based on the target panoramic image and the target panoramic screenshot, where the angle information of the target panoramic screenshot includes at least one of following items: a pitch angle, a roll angle and a yaw angle of the target panoramic screenshot relative to the target panoramic image; and associating the angle information of the target panoramic screenshot with the target point of interest.

In the embodiment of the present disclosure, after the target panoramic screenshot has been determined, the target panoramic image corresponding to the target panoramic screenshot may further be acquired. That is, the target panoramic screenshot is one of the panoramic screenshots stitched together to form the target panoramic image, and the angle information of the target panoramic screenshot relative to the target panoramic image is further acquired. As shown in FIG. 2, the target panoramic screenshot 10 may be considered as a panoramic spherical model, and the target panoramic screenshot 20 includes the target text information 30. An angle of the target panoramic screenshot 20 in the panoramic spherical model may be calculated through a transformation projection matrix of the target panoramic screenshot 20 and the panoramic spherical model, and the calculated angle may include at least one of: the pitch angle, the roll angle or the yaw angle, so that the angle information of the target panoramic screenshot may be acquired. The angle information of the target panoramic screenshot may be calculated according to techniques in the related art, which will not be defined in detail in this embodiment.

Further, after the angle information of the target panoramic screenshot has been acquired, the angle information of the target panoramic screenshot is associated with the target point of interest. For example, a corresponding relationship between the target point of interest and the angle information of the target panoramic screenshot is established, and when the user selects the target point of interest to view the panoramic image, the target panoramic screenshot is displayed based on the associated angle information of the target panoramic screenshot. In this way, when the user is viewing the panoramic image of the target point of interest, the target panoramic screenshot having a better viewing angle and higher image quality is first seen by the user. The target text information may be seen directly through the target panoramic screenshot, thereby providing the user with better navigational guidance experience.

Optionally, subsequent to step S104, the method may further include: in the case of receiving a trigger operation for the target point of interest, displaying the target panoramic screenshot.

The trigger operation may be a touch operation that the user performs on the device, for example, to view the panoramic image of the target point of interest. For example, in the case that a target point of interest is displayed on an electronic map, when the device receives a trigger operation of double-clicking the target point of interest of the user, it means that the user wants to view the panoramic image of the target point of interest, and then the target panoramic screenshot is displayed. Next, viewing angle of the panoramic image may be changed by receiving a sliding operation such as rotating and dragging on the target panoramic screenshot, i.e., other panoramic screenshots corresponding to the panoramic image are switched and displayed.

It should be appreciated that, the target point of interest is associated with the angle information of the target panoramic screenshot. When a touch operation that the user wants to view the target point of interest is received, the angle information associated with the target point of interest may be acquired. That is, the corresponding target panoramic screenshot may be acquired based on the angle information and displayed. The target panoramic screenshot includes the target text information, so that the user may view the target text information quickly, and acquire a relevant content of the current target point of interest visually, such as the name of the target point of interest, thereby providing the user with position indication and navigational guidance experience more effectively. For example, for an unfamiliar region, the user may learn about the target point of interest visually and effectively when viewing a target panoramic screenshot associated with a target point of interest in the region and target text information in the panoramic screenshot, so that it is more convenient for the user to know the region quickly, thereby to provide the user with better navigational guidance experience, and improve user experience.

In the technical solution provided by the embodiments of the present disclosure, the target text information of the target point of interest is identified, so as to acquire the set of panoramic images including the target text information among the plurality of panoramic images associated with the target point of interest. The panoramic screenshot corresponding to each panoramic image in the set of panoramic images is acquired, so as to acquire the set of panoramic screenshots. The target panoramic screenshot in the set of panoramic screenshots is determined, the target panoramic screenshot is associated with the target point of interest, and the target panoramic screenshot includes the target text information. In this way, the panoramic screenshot is associated with the point of interest automatically, and the target panoramic screenshot is one of the panoramic screenshots stitched together to form the target panoramic image, and thus the panoramic image is associated with the point of interest. Compared with a case that a panoramic image is associated with a point of interest manually in the prior art, subjective factors caused by a manual operation can be avoided in the technical solution provided by the embodiment of the present disclosure, thereby improving the association efficiency.

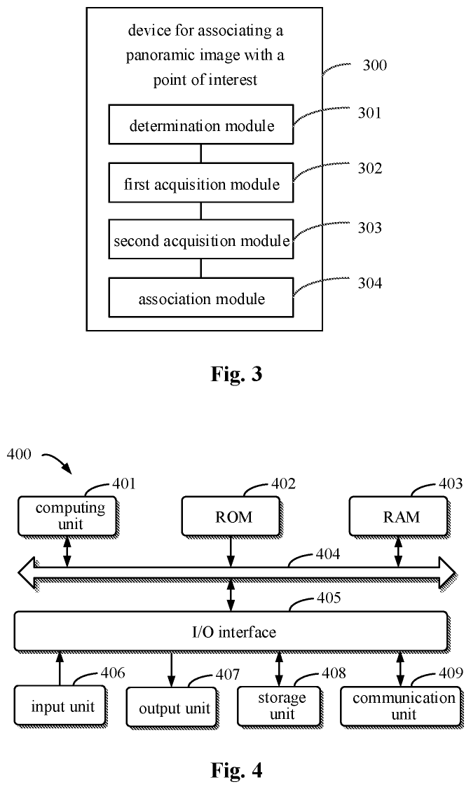

A device for associating a panoramic image with a point of interest is further provided in the present disclosure. As shown in FIG. 3, the device for associating the panoramic image with the point of interest 300 includes: a determination module 301, configured to perform text recognition on a panoramic image associated with a target point of interest, and determine target text information; a first acquisition module 302, configured to acquire a set of panoramic images including the target text information among a plurality of panoramic images associated with the target point of interest; a second acquisition module 303, configured to acquire a panoramic screenshot corresponding to each panoramic image in the set of panoramic images to acquire a set of panoramic screenshots, where one panoramic image is formed by stitching a plurality of panoramic screenshots together; and an association module 304, configured to determine a target panoramic screenshot in the set of panoramic screenshots, and associate the target panoramic screenshot with the target point of interest, where the target panoramic screenshot includes the target text information.

Optionally, the association module 304 is further configured to acquire a score value of each panoramic screenshot in the set of panoramic screenshots based on a preset scoring rule, and determine the target panoramic screenshot in the set of panoramic screenshots based on the score value.

Optionally, the association module 304 is further configured to acquire an image parameter of each panoramic screenshot in the set of panoramic screenshots, where the image parameter includes at least one of following items: image brightness, image contrast, a display position of the target text information in the panoramic screenshot, a display size of the target text information in the panoramic screenshot, and angle information corresponding to the panoramic screenshot; acquire a score value of each panoramic screenshot based on a preset scoring model, where the preset scoring model is a network model of which an input is the image parameters and an output is the score value; and determine the panoramic screenshot having a highest score value as the target panoramic screenshot.

Optionally, the association module 304 is further configured to: acquire a target panoramic image corresponding to the target panoramic screenshot; acquire angle information of the target panoramic screenshot based on the target panoramic image and the target panoramic screenshot, where the angle information of the target panoramic screenshot includes at least one of following items: a pitch angle, a roll angle and a yaw angle of the target panoramic screenshot relative to the target panoramic image; and associate the angle information of the target panoramic screenshot with the target point of interest.

Optionally, the device for associating the panoramic image with the point of interest 300 further includes a display module configured to display the target panoramic screenshot, in the case of receiving a trigger operation for the target point of interest.

The device for associating the panoramic image with the point of interest 300 can implement all the technical solutions of the above-mentioned method for associating the panoramic image with the point of interest, and at least achieve all the technical effects described above. To avoid repetition, details are not described herein again.

According to embodiments of the present disclosure, an electronic device, a readable storage medium and a computer program product are further provided.

FIG. 4 shows a block diagram of an electronic device 400 for implementing the embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital assistant, cellular telephones, smart phones, wearable devices, and other similar computing devices. The components shown herein, their connections and relationships, and their functions are by way of example only and are not intended to limit the implementations of the present disclosure described and/or claimed herein.

As shown in FIG. 4, the electronic device 400 includes a computing unit 401, which may perform various appropriate operations and processing based on a computer program stored in a read only memory (ROM) 402 or loaded from a storage unit 408 to a random access memory (RAM) 403. In the RAM 403, various programs and data required for the operation of the electronic device 400 may also be stored. The computing unit 401, the ROM 402 and the RAM 403 are connected to each other through a bus 404. An input/output (I/O) interface 405 is also connected to the bus 404.

A plurality of components in the electronic device 400 is connected to the I/O interface 405, including: an input unit 406, such as a keyboard, a mouse, an output unit 407, such as various types of displays, speakers, a storage unit 408, such as a disk, an optical disc, and a communication unit 409, such as a network card, a modem, a wireless communication transceiver. The communication unit 409 allows the electronic device 400 to exchange information/data with other devices through a computer network such as the Internet and/or various telecommunication networks.

The computing unit 401 may be various general-purpose and/or dedicated processing components having processing and computing capabilities. Some examples of the computing unit 401 include, but are not limited to, a central processing unit (CPU), a graphics processing unit (GPU), various dedicated artificial intelligence (AI) computing chips, various computing units that run machine learning model algorithms, a digital signal processing (DSP), and any appropriate processor, controller, microcontroller, etc. The computing unit 401 performs the various methods and processing described above, such as the method for associating the panoramic image with the point of interest. For example, the method for associating the panoramic image with the point of interest may be implemented as a computer software program in some embodiments, which is tangibly included in a machine-readable medium, such as the storage unit 408. In some embodiments, a part or all of the computer program may be loaded and/or installed on the electronic device 400 through the ROM 402 and/or the communication unit 409. When the computer program is loaded into the RAM 403 and executed by the computing unit 401, one or more steps of the method for associating the panoramic image with the point of interest described above may be implemented. Alternatively, in other embodiments, the computing unit 401 may be configured to perform the method for associating the panoramic image with the point of interest in any other suitable manner (for example, by means of firmware).

Various embodiments of the systems and techniques described herein may be implemented in a digital electronic circuitry, an integrated circuit system, a field programmable gate array (FPGA), an application-specific integrated circuits (ASIC), an application-specific standard products (ASSP), a system on chip system (SOC), a complex programmable logic device (CPLD), computer hardware, firmware, software, and/or a combination thereof. These various embodiments may include implementation in one or more computer programs that may be executed and/or interpreted on a programmable system including at least one programmable processor, which may be a dedicated or general purpose programmable processor, that may receive data and instructions from a storage system, at least one input device and at least one output device, and transmit the data and the instructions to the storage system, the at least one input device and the at least one output device.

Program codes used to implement the method of the present disclosure may be written in any combination of one or more programming languages. These program codes may be provided to the processor or controller of the general-purpose computer, the dedicated computer, or other programmable data processing devices, so that when the program codes are executed by the processor or controller, functions/operations specified in the flowcharts and/or block diagrams are implemented. The entire program codes or a part of the program codes may be executed on a machine. As an independent software package, a part of the program codes formed is executed on the machine and a part of the program codes is executed on a remote machine, or the entire program codes are executed on a remote machine or server.

In the present disclosure, the machine-readable medium may be a tangible medium, which may include or store a program used by an instruction execution system, apparatus or device, or a combination of the instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage media may include electrical connections based on one or more wires, a portable computer disk, a hard disk, a random access memory (RAM), a read-only memory (ROM), an erasable programmable read-only memory (EPROM or flash EPROM), an optical fiber, a compact disk read-only memory (CD-ROM), an optical storage device, a magnetic storage device, or any suitable combination thereof.

To provide interaction with a user, the system and technique described herein may be implemented on a computer having: a display device (e.g., a cathode ray tube (CRT) or liquid crystal display (LCD) monitor) for displaying information to the user; a keyboard and a pointing device (e.g., a mouse or a trackball) through which the user may provide an input to the computer. Other types of devices may also be used to provide interaction with the user; for example, a feedback provided to the user may be any form of sensory feedback (e.g., visual feedback, auditory feedback, or tactile feedback); and the input from the user may be received in any form, including acoustic input, voice input, or tactile input.

The system and technique described herein may be implemented in a computing system that includes a background component (e.g., as a data server), or a computing system that includes a middleware component (e.g., an application server), or a computing system that includes a front-end component (e.g., a user computer having a graphical user interface or a web browser through which a user may interact with implementations of the system and technique described herein), or a computing system that includes any combination of the background component, middleware component, or front-end component. The components of the system may be interconnected by any form or medium of digital data communication (e.g., a communication network). Examples of communication networks include: Local Area Networks (LANs), Wide Area Networks (WANs), and the Internet.

The computer system may include a client and a server. The client and server are typically far away from each other and typically interact through a communication network. The relationship of the client and the server is generated by computer programs running on respective computers and having a client-server relationship with each other.

It should be appreciated that the various forms of flows described above may be used, and the steps may be reordered, added or deleted. For example, the steps recited in the present disclosure may be performed in parallel or sequentially or may be performed in a different order, so long as the desired results of the technical solutions disclosed in the present disclosure can be achieved, and no limitation is made herein.

The above-described embodiments are not construed as a limitation to the scope of the present disclosure. It will be apparent to those skilled in the art that various modifications, combinations, sub-combinations and substitutions can be performed based on design requirements and other factors. Any modifications, equivalents, and improvements within the spirit and principles of the present disclosure shall fall within the protection scope of the present disclosure.

What is claimed is:

1. A method for associating a panoramic image with a point of interest, comprising:
performing text recognition on a panoramic image associated with a target point of interest, and determining target text information;
acquiring a set of panoramic images comprising the target text information among a plurality of panoramic images associated with the target point of interest;
acquiring a panoramic screenshot corresponding to each panoramic image in the set of panoramic images to acquire a set of panoramic screenshots, wherein one panoramic image is formed by stitching a plurality of panoramic screenshots together; and
determining a target panoramic screenshot in the set of panoramic screenshots, and associating the target panoramic screenshot with the target point of interest, wherein the target panoramic screenshot comprises the target text information.

2. The method according to claim 1, wherein the determining the target panoramic screenshot in the set of panoramic screenshots comprises:
acquiring a score value of each panoramic screenshot in the set of panoramic screenshots based on a preset scoring rule, and determining the target panoramic screenshot in the set of panoramic screenshots based on the score value.

3. The method according to claim 1, wherein the determining the target panoramic screenshot in the set of panoramic screenshots comprises:
acquiring an image parameter of each panoramic screenshot in the set of panoramic screenshots, wherein the image parameter comprises at least one of following items: image brightness, image contrast, a display position of the target text information in the panoramic screenshot, a display size of the target text information in the panoramic screenshot, and angle information corresponding to the panoramic screenshot;
acquiring a score value of each panoramic screenshot based on a preset scoring model, wherein the preset scoring model is a network model of which an input is the image parameter and an output is the score value; and
determining the panoramic screenshot having a highest score value as the target panoramic screenshot.

4. The method according to claim 1, wherein the associating the target panoramic screenshot with the target point of interest comprises:
acquiring a target panoramic image corresponding to the target panoramic screenshot;
acquiring angle information of the target panoramic screenshot based on the target panoramic image and the target panoramic screenshot, wherein the angle information of the target panoramic screenshot comprises at least one of following items: a pitch angle, a roll angle, and a yaw angle of the target panoramic screenshot relative to the target panoramic image; and
associating the angle information of the target panoramic screenshot with the target point of interest.

5. The method according to claim 1, further comprising: displaying the target panoramic screenshot, in the case of receiving a trigger operation for the target point of interest.

6. A device for associating a panoramic image with a point of interest, comprising:
at least one processor; and
a memory communicatively coupled to the at least one processor; wherein the memory stores thereon an instruction that is executable by the at least one processor, and when executing the instruction, the at least one processor is configured to:
perform text recognition on a panoramic image associated with a target point of interest, and determine target text information;
acquire a set of panoramic images comprising the target text information among a plurality of panoramic images associated with the target point of interest;
acquire a panoramic screenshot corresponding to each panoramic image in the set of panoramic images to acquire a set of panoramic screenshots, wherein one panoramic image is formed by stitching a plurality of panoramic screenshots together; and
determine a target panoramic screenshot in the set of panoramic screenshots, and associate the target panoramic screenshot with the target point of interest, wherein the target panoramic screenshot comprises the target text information.

7. The device according to claim 6, wherein the at least one processor is further configured to:
acquire a score value of each panoramic screenshot in the set of panoramic screenshots based on a preset scoring rule, and determine the target panoramic screenshot in the set of panoramic screenshots based on the score value.

8. The device according to claim 6, wherein the at least one processor is further configured to:
acquire an image parameter of each panoramic screenshot in the set of panoramic screenshots, wherein the image parameter comprises at least one of following items: image brightness, image contrast, a display position of the target text information in the panoramic screenshot, a display size of the target text information in the panoramic screenshot, and angle information corresponding to the panoramic screenshot;
acquire a score value of each panoramic screenshot based on a preset scoring model, wherein the preset scoring model is a network model of which an input is the image parameter and an output is the score value; and
determine the panoramic screenshot having a highest score value as the target panoramic screenshot.

9. The device according to claim 6, wherein the at least one processor is further configured to:
acquire a target panoramic image corresponding to the target panoramic screenshot;
acquire angle information of the target panoramic screenshot based on the target panoramic image and the target panoramic screenshot, wherein the angle information of the target panoramic screenshot comprises at least one of following items: a pitch angle, a roll angle, and a yaw angle of the target panoramic screenshot relative to the target panoramic image; and
associate the angle information of the target panoramic screenshot with the target point of interest.

10. The device according to claim 6, wherein the at least one processor is further configured to:
display the target panoramic screenshot, in the case of receiving a trigger operation for the target point of interest.

11. A non-transitory computer-readable storage medium having stored a computer instruction thereon, wherein the computer instruction is configured to cause a computer to perform following steps:
performing text recognition on a panoramic image associated with a target point of interest, and determining target text information;
acquiring a set of panoramic images comprising the target text information among a plurality of panoramic images associated with the target point of interest;
acquiring a panoramic screenshot corresponding to each panoramic image in the set of panoramic images to acquire a set of panoramic screenshots, wherein one panoramic image is formed by stitching a plurality of panoramic screenshots together; and
determining a target panoramic screenshot in the set of panoramic screenshots, and associating the target panoramic screenshot with the target point of interest, wherein the target panoramic screenshot comprises the target text information.

12. The non-transitory computer-readable storage medium according to claim 11, wherein when determining the target panoramic screenshot in the set of panoramic screenshots, the computer instruction is further configured to cause the computer to perform following steps:
acquiring a score value of each panoramic screenshot in the set of panoramic screenshots based on a preset scoring rule, and determining the target panoramic screenshot in the set of panoramic screenshots based on the score value.

13. The non-transitory computer-readable storage medium according to claim 11, wherein when determining the target panoramic screenshot in the set of panoramic screenshots, the computer instruction is further configured to cause the computer to perform following steps:
acquiring an image parameter of each panoramic screenshot in the set of panoramic screenshots, wherein the image parameter comprises at least one of following items: image brightness, image contrast, a display position of the target text information in the panoramic screenshot, a display size of the target text information in the panoramic screenshot, and angle information corresponding to the panoramic screenshot;
acquiring a score value of each panoramic screenshot based on a preset scoring model, wherein the preset scoring model is a network model of which an input is the image parameter and an output is the score value; and
determining the panoramic screenshot having a highest score value as the target panoramic screenshot.

14. The non-transitory computer-readable storage medium according to claim 11, wherein when associating the target panoramic screenshot with the target point of interest, the computer instruction is further configured to cause the computer to perform following steps:
acquiring a target panoramic image corresponding to the target panoramic screenshot;
acquiring angle information of the target panoramic screenshot based on the target panoramic image and the target panoramic screenshot, wherein the angle information of the target panoramic screenshot comprises at least one of following items: a pitch angle, a roll angle, and a yaw angle of the target panoramic screenshot relative to the target panoramic image; and
associating the angle information of the target panoramic screenshot with the target point of interest.

15. The non-transitory computer-readable storage medium according to claim 11, wherein the computer instruction is further configured to cause the computer to perform following steps:
displaying the target panoramic screenshot, in the case of receiving a trigger operation for the target point of interest.
